(19) United States
(12) Patent Application Publication
(10) Pub. No.: US 2022/0188889 A1
(43) Pub. Date: Jun. 16, 2022

(54) TECHNOLOGIES FOR REAL TIME COMMUNICATIONS

(71) Applicant: Merge In, LLC, Cincinnati, OH (US)

(72) Inventor: Stephen Beckham, JR., Cincinnati, OH (US)

(21) Appl. No.: 17/665,101

(22) Filed: Feb. 4, 2022

Related U.S. Application Data
(63) Continuation of application No. 16/378,284, filed on Apr. 8, 2019, now abandoned.
(60) Provisional application No. 62/665,400, filed on May 1, 2018.

(51) Int. Cl. G06Q 30/06; H04N 7/14

(52) U.S. Cl. CPC G06Q 30/0613; G06Q 30/01; G06Q 30/0641; H04N 7/147

(57) ABSTRACT

A system and method for communication between business representatives and consumers, the method including the steps of: providing a server comprising one or more computer-readable media maintaining instructions executable by a processor of an electronic device to perform operations comprising presenting on a consumer electronic device a digital image comprising a system-connected business profile page comprising one or more items for sale and a system icon; receiving, by the consumer electronic device, a selection of the system icon; connecting the consumer electronic device to a business electronic device associated with the system-connected business profile page; inviting a system-connected business representative to accept participation with the consumer; receiving, by the business electronic device, a selection to accept participation with the consumer; initiating a video call between the consumer and the business representative; adding at least one item of the one or more items to an online shopping cart; paying for the at least one item; and ending the call.

### CROSS-REFERENCE TO RELATED APPLICATIONS

The present application claims the priority of U.S. Provisional Patent Application Ser. No. 62/665,400, entitled TECHNOLOGIES FOR REAL TIME COMMUNICATIONS, filed May 1, 2018, and U.S. Non-Provisional patent application Ser. No. 16/378,284, entitled TECHNOLOGIES FOR REAL TIME COMMUNICATIONS, filed Apr. 8, 2019, and hereby incorporates the same application herein by reference in its entirety.

### TECHNICAL FIELD

Embodiments of the technologies described herein relate, in general, to media streaming technologies, and in particular to real time communication systems and methods.

### BACKGROUND

Online collaboration and social media are becoming ubiquitous tools for personal, business, and social uses. For example, organizations may utilize various online collaboration and social media tools to, among other things, conduct meetings and webinars, provide online training or eLearning opportunities to employees and other interested individuals, remotely demonstrate products or services to prospective and existing customers, and provide customer service and technical support over the Internet. Online collaboration and social media can also be used by organizations and individual representatives as a communication tool. For example, various social media tools such as electronic posts may be used by individual representatives to communicate or share information with other representatives. Oftentimes, such electronic posts include static or previously generated content such as graphics, electronic photographs, textual comments, and prerecorded video content. That is, electronic posts are often static one-way posts that offer other representatives little opportunity to interact therewith.

Online interaction between consumers and businesses, or businesses to businesses can be hindered by lack of real-time communication. Further, consumer-meaningful communication can be hindered by the “friction” of time-consuming, delayed, and impersonal communication. Often this friction causes the loss of sales at or near the point of sale.

Accordingly, there remains an unmet need for collaboration tools that can reduce the “friction” of consumer to business or business to business communication.

Further, there remains an unmet need for systems and methods for business or organizations to communicate directly with consumers, and vice-versa.

### BRIEF DESCRIPTION OF THE DRAWING

FIG. 1 is a schematic representation of a device of the system of the present disclosure.

FIG. 2 is a representative screen shot of the system of the present disclosure.

FIG. 3 is a representative screen shot of the system of the present disclosure.

FIG. 4 is a representative screen shot of the system of the present disclosure.

FIG. 5 is a representative screen shot of the system of the present disclosure.

FIG. 6 is a representative screen shot of the system of the present disclosure.

FIG. 7 is a representative screen shot of the system of the present disclosure.

FIG. 8 is a representative screen shot of the system of the present disclosure.

FIG. 9 is a representative screen shot of the system of the present disclosure.

FIG. 10 is a representative screen shot of the system of the present disclosure.

FIG. 11 is a representative screen shot of the system of the present disclosure.

FIG. 12 is a representative screen shot of the system of the present disclosure.

FIG. 13 shows representative screen shots of the system of the present disclosure.

FIG. 14 shows representative screen shots of the system of the present disclosure.

FIG. 15 is a representative screen shot of the system of the present disclosure.

FIG. 16 is a representative screen shot of the system of the present disclosure.

FIG. 17 is a representative screen shot of the system of the present disclosure.

FIG. 18 is a flow diagram of a representative method of the present disclosure.

FIG. 19 is a continuation of the flow diagram of a representative method of the present disclosure of FIG. 18.

FIG. 20 is a continuation of the flow diagram of a representative method of the present disclosure of FIGS. 18 and 19.

### DESCRIPTION

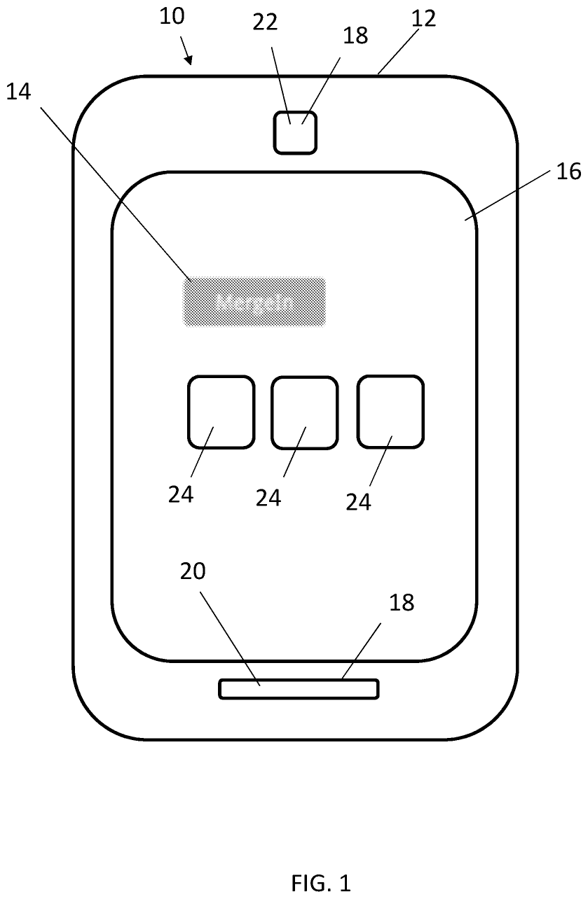

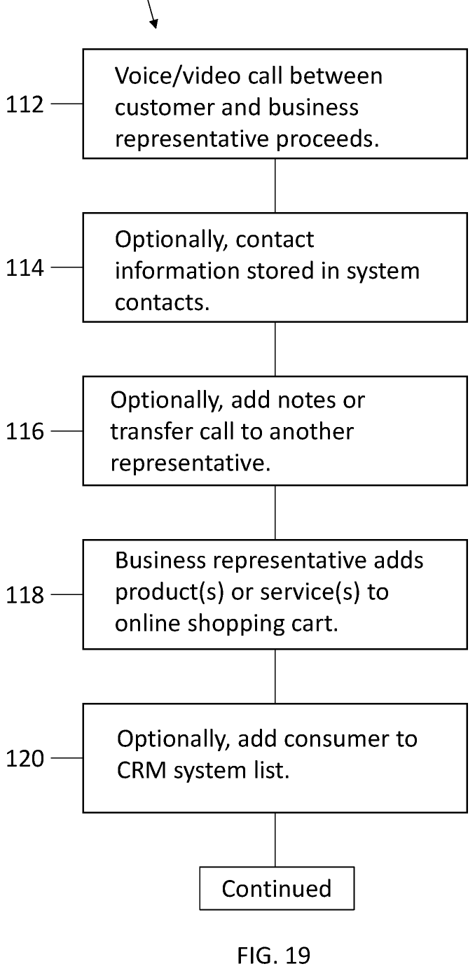

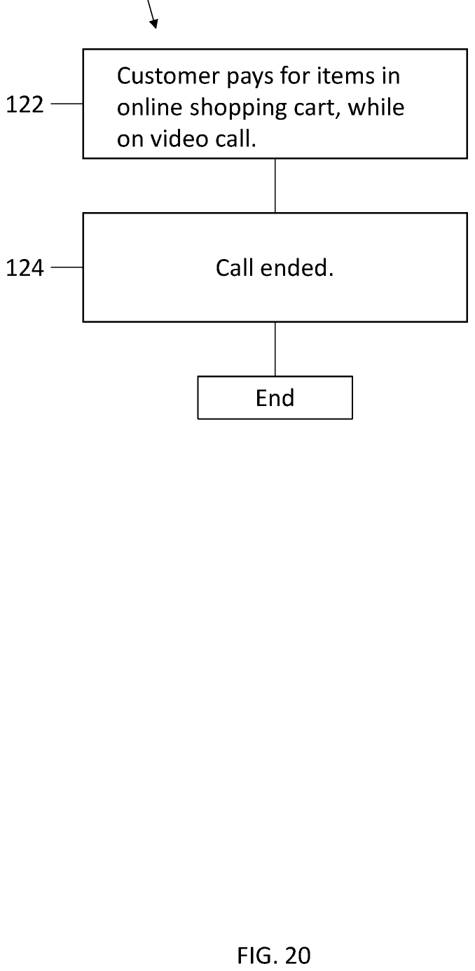

Various non-limiting embodiments of the present disclosure will now be described to provide an overall understanding of the principles of the structure, function, and use of systems and methods disclosed herein. One or more examples of these non-limiting embodiments are illustrated in the selected examples disclosed and described in detail with reference made to FIGS. 1-20 in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. In addition, elements illustrated in the figures are not necessarily drawn to scale for simplicity and clarity of illustration. For ease of reading and clarity, certain components, modules, or methods may be described solely in connection with a specific figure.

In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be misunderstood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. Likewise, the terms “select,” “click,” “touch,” and the like can be used interchangeably and refer to a user making a selection from a screen display. It should be noted that for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

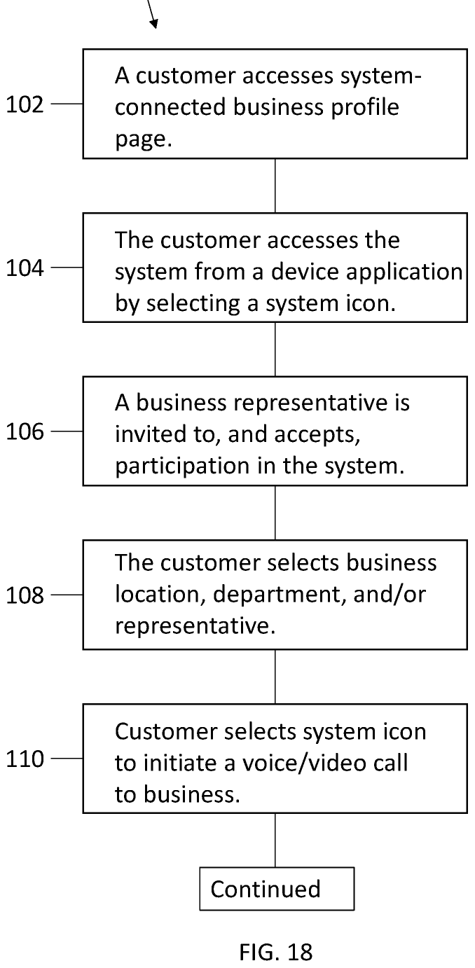

The systems, devices, and methods described herein will be described with respect to example devices and illustrative screen shots in FIGS. 1-17, and a representative flow diagram shown in FIGS. 18-20. In general, the systems, devices, and methods described herein can provide for real-time video streaming and communications between organizations, including businesses, and including communications as part of a sales platform. The systems, devices and methods disclosed herein can allow sales associates, customer support representatives and/or employee/contractor or someone who invited to a business location or department account by a business admin to communicate with online clients and potential clients. The systems, devices and methods described herein can facilitate a frictionless interaction that can including the sending of payments and completion of sales transactions, including by facilitating video chatting with people online. Calls from customers and potential customers can be connected or forwarded to the available sales or customer representatives, including from a virtual business location or department via a live video. Business admins have options to direct video calls to his/her organization locations or department calling que or allow viewers to place realtime video calls into a live video stream and if accepted by business video streamers viewers have the ability to join in a the real-time video live stream.

The systems, devices, and methods described herein can also provide for organization's existing customer, business-to-business (B2B) clients, consumers, social media followers, contacts from customer relationship management (CRM) systems or anyone who has been invited to a sales associate digital business contacts list by, for example, test (SMS) invite, email, website visitors, white label application representatives, or anyone who has access to the internet to have on-demand realtime video/audio or text access to the organizations” business representatives, customer service representative, the organization's contractors location or department calling queue, or anyone within an organization who has been invited to the communication.

A system 10 is described herein providing the following features and benefits. The system facilitates an organizations' sales associates, customer support reps, employees or contractors to connect and communicate with new and existing clients from multiple touch points.

Further, the system 10 facilitates an organizations' sales associates, customer support reps, employees or contractors to send payments to B2B clients, receive payment and complete a sales transactions while on a video call or after a video call has ended.

Further, the system 10 facilitates an organizations' sales associates, customer support reps, employees or contractors to create a customized price for a product or service and add it to a customers or client cart, including while on a video call.

Further, the system 10 facilitates an organizations' sales associates, customer support reps, employees or contractors to add multiple products or services to a client's customer cart, including while video chatting, for example, by selecting a “Add New Item” button as described herein.

Further, the system 10 facilitates an organizations' sales associates, customer support reps, employees or contractors to receive a customized percentage of each sales transaction that he/she completes from all sales transactions completed.

Further, the system 10 facilitates an organizations' sales associates, customer support reps, employees or contractors to manually collect customer/client data from any touchpoint, update existing client information, add new clients and new client data to a system contacts database or CRM.

Further, the system 10 facilitates an organizations' sales associates, customer support reps, employees, contractors or a system business account admins or location admin to have on demand real-time video/audio or text access to location or departments business contacts or a list personal business contacts, customers or clients.

Further, the system 10 facilitates live video viewers and online advertisement call routing and allows organizations' sales associates, customer support reps, employees or contractors the ability to connect in real-time video/audio or text with live video stream viewers or consumers who have accessed the system via the system icon, as discussed below, or other customized button while viewing a live or ended video stream or from someone who has selected the system icon from an online advertisement.

Further, the system 10 facilitates consumer on-demand access via real-time video, audio, or text to a system organization's locations, departments, sales associates, customers support reps, employees, and/or contactors.

The system 10 can be maintained and executed on servers maintained, for example, by a system owner, and executed in the form of online websites, mobile applications, and the like through which businesses and consumers (also referred to herein as customers or callers) can participate in the system. The system can be maintained on servers comprising computer-readable media, executable instructions, processors, and the like as is known in the art of web-enabled and/or app-enabled online interactions. Thus, in an embodiment, the system 10 comprises a system server that can be a cloud-based server, business-side devices that can be business electronic devices can be mobile devices such as tablets or smart phones, and consumer-side devices that can be consumer electronic devices, for example smart phones. The various server(s) and devices can be connected via, for example, the internet or other networking system, including cloud computing.

A representative method of the present disclosure can proceed at step 102 of the process of flow diagram 100 of FIG. 18 showing a representative process flow for the system 10, and with reference to FIG. 1. FIG. 1 shows a representative system 10 component, including a represtative device 12, which can be a tablet, smart phone, computer, mobile device, or any device with access to the internet over a browser or an application. Device 12 can be an electronic device comprising computer-readable media maintaining instructions by a processor to perform the operations described herein. Device 12 can have a display screen 16 and input/output features 18 as is known in the art of electronic communications devices. For example, a device 12 can have a microphone 20, a camera 22 for photos and video, and icons 24 as are known in the art of, for example, smart phones as selectable features that can be selected, for example, by touching or clicking.

In an embodiment, one of the selectable icons 24 can be a system icon 14, and can be utilized for a customer to access and navigate the system of the present disclosure from a device application, as indicated at 102 of flow diagram 100. Selecting system icon 14 can start a process including initiating a real-time video or voice call placed into a system-connected business, including a specific business location or department. In an embodiment, business associates that have been invited to a specific call can answer or make incoming and outcoming calls from online inquiries.

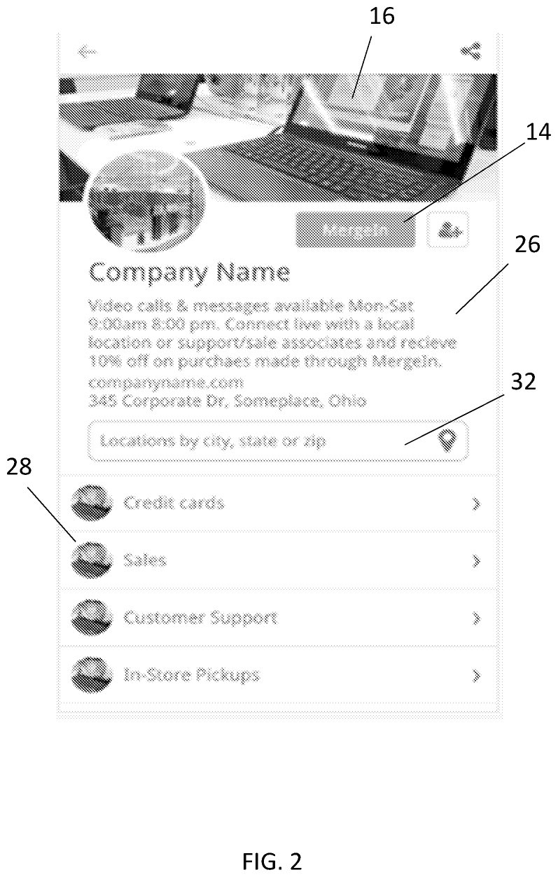

In an embodiment, when a customer selects system icon 14, the customer can have displayed on the device screen 16 a system-connected business profile page 26, as indicated at FIG. 2, and per step 104 of flow diagram 100. The business profile page 26 can be prepared and made available electroncially by a system-connected business and can have multiple departments, sub-departments, and/or locations 28 indicated on the screen 16, such as, for example, “sales”.

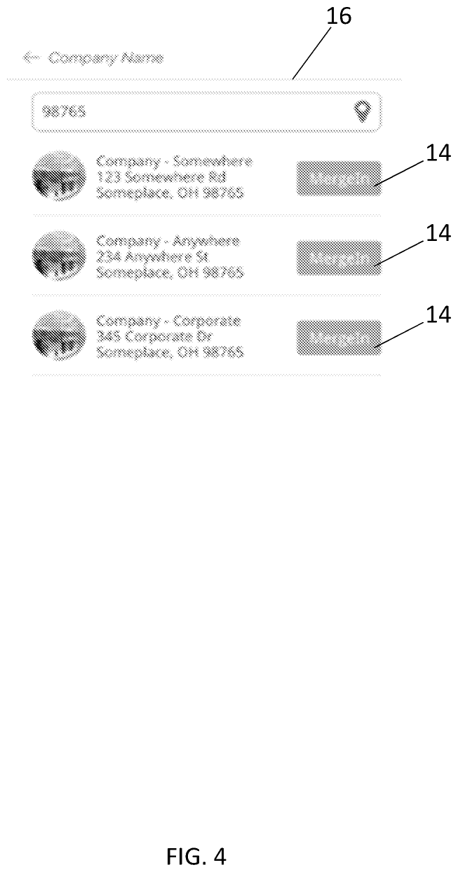

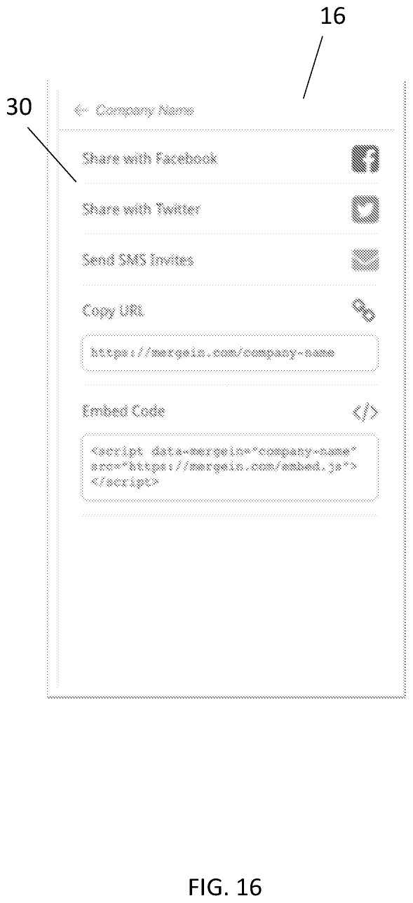

Sub-departments and locations shown on the business profile page 26 can be physical business locations and departments within a specific organization. In an embodiment, a business representative, such as an administrator can send SMS or email invites to employees within his/her organization and attach them to the appropriate portion of the business profile, and which can match the department or location at which the subject employee works day to day. Employees can also be invited to a department or location account or calling queue by other means, such as via social media sites 30, as shown on FIG. 16, and indicated at step 106 of follow diagram 100. Consumers can access any department or location within a specific business by selecting (e.g., by clicking, touching, or voice command) a department 28 or by entering information such as city or zip code in a search area 32 of screen 16, as indicated at step 108 of flow diagram 100. If utilizing the search feature, the consumer can be directed to a page as shown in FIG. 4.

In an embodiment, the screen shot of FIG. 1, and at least the system icon 14, can be displayed on an online advertisement, including a live stream video advertisement, business website, B2B client or customer contact list, white labeled application, social media profile page, blog, or other online site. When the system icon 14 is selected, the system can enable and facilitate a real-time video or audio call to a system business, sales associate, customer support representative, employee with a system business (referred to herein as a “business representative”), business location, department or personal calling queue, as described herein.

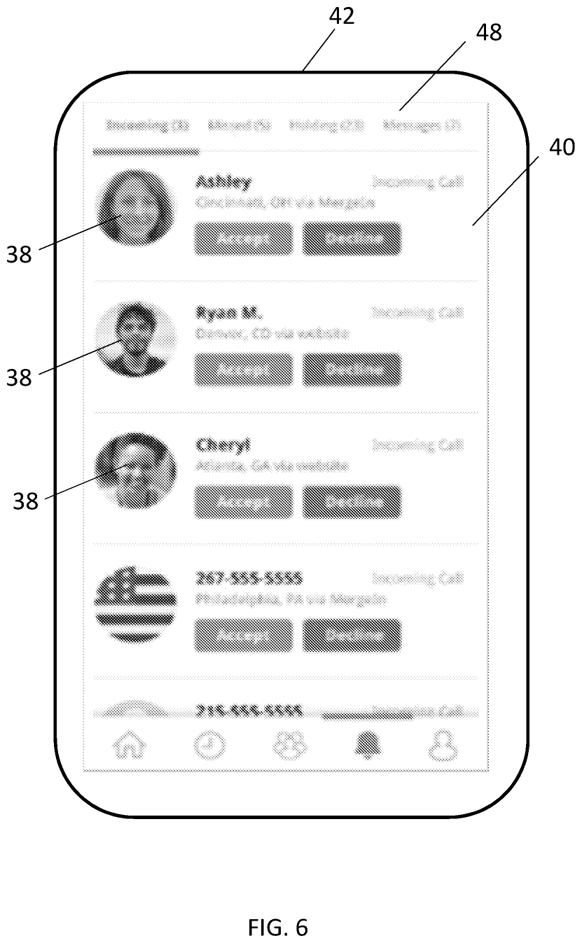

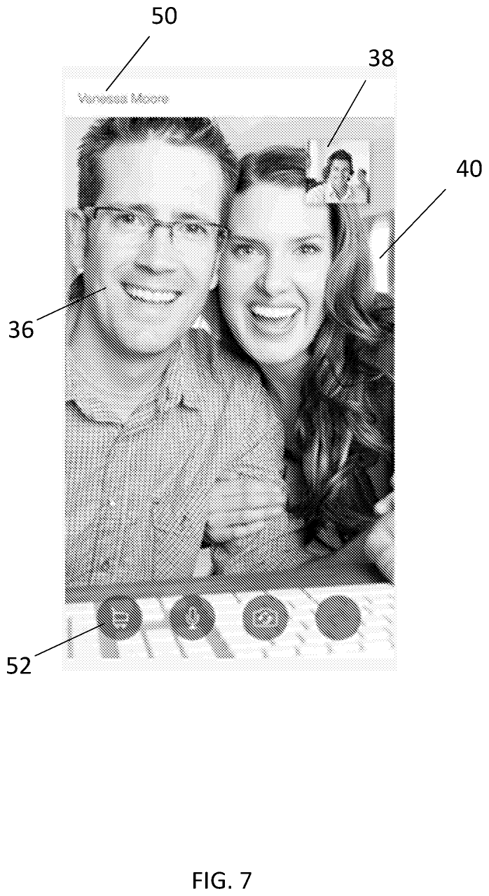

As shown in FIG. 2, system icon 14 can be duplicated on the business profile page 26. When the system icon 14 on the business profile page 26 is selected by a consumer while viewing a specific location department profile page, a real-time video call can be placed to that specific business department or location calling queue, as indicated at step 110 of flow diagram 100. A representative screen shot 40 of the business-side of this transaction (on a business device 42, such as a computer or tablet or smart phone) is shown in FIG. 6. Once a call is accepted by a sales or customers service representative that has been invited to accept calls from that department, callers and business associates will then be connected in a real-time video conversation, as indicated in FIG. 7 showing one or more consumers 36 and a representative 38, for example, sales associate in a video call as shown on the consumer's device 12 screen 16, and as indicated at step 112 of flow diagram 100.

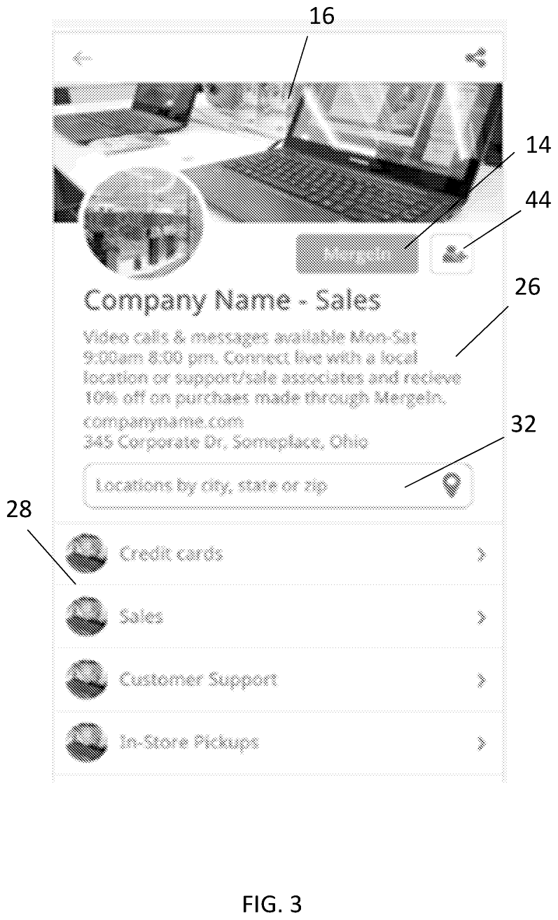

An example embodiment of initiating a call to a sales department is shown in FIG. 3. As indicated, an organization's sales department profile page can be shown on screen 16 if a consumer selects “Sales” on the company profile page. Upon selection of, for example “Sales”, the consumer can be directed the organization's Sales profile page, where the consumer can then again select system icon 14 to initiate a real-time video call into that organization's Sales department. In addition, in an embodiment consumers can share the sales (or any other) department link online to social media followers and mobile contacts, for example, by selecting a share link 44.

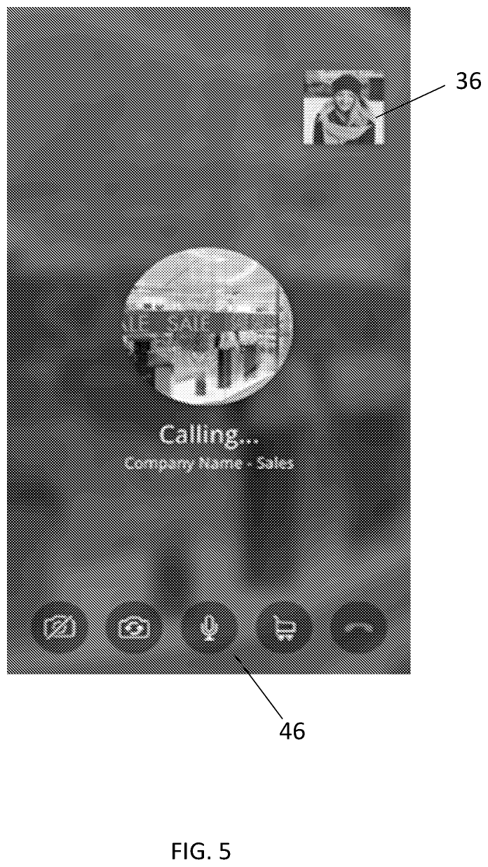

FIG. 4 shows a representative screen view of the selections presented when a consumer utilizes the search feature 32 discussed above with respect to FIG. 2. Once a person types a city name or zip code inside the search feature 32, a list of business locations or departments can appear with the system icon 14 next to each location or department. When one of the icons 14 is selected, a real-time video or audio call can be initiated to the relevant sales or customer support associate's calling queue. A representative screen view of the consumer's device is indicated in FIG. 5, in which the call is in progress and the calling consumer 36 can be shown on the top right of the screen with selectable options 46 on the bottom navigation bar for the caller to, for example, switch camera, mute, turn the camera off, view what's in his/ her cart and make purchases while video chatting with a business associate. The relevant sales or customer support associate can be one connected to a specific location or department's calling queue, again as shown at FIG. 6. The relevant sales or customer support associate can be invited by a business admin to work in, for example, the sales department within his/her organization by email or SMS message. Once the call is answered by a business the consumer and business associates are then connected in a real-time conversation via, for example, a mobile device or computer. In an embodiment no download of any content, application, software or other information is required.

Referring again to FIG. 6, there is shown a representative business/organization side screen shot of a display 40, and specifically shows a representative calling queue that can be accessed when a consumer selects system icon 14, which can be an imbedded coded snippet on a webpage, application or anywhere online. A real-time video or audio call can be placed to the specific business location or department's calling queue that is attached to a webpage. An incoming real-time video or audio call can be received and directed representatives 38 in a calling queue as shown in FIG. 6. As shown in FIG. 6, the screen 40 can also show in a section 48 thereof, missed, incoming calls, messages and a section where callers are in a holding queue waiting for the next available brand associate to take the call. Once the accept button is selected by a representative 38 the caller and business associates can then be connected in a real-time video or audio conversation.

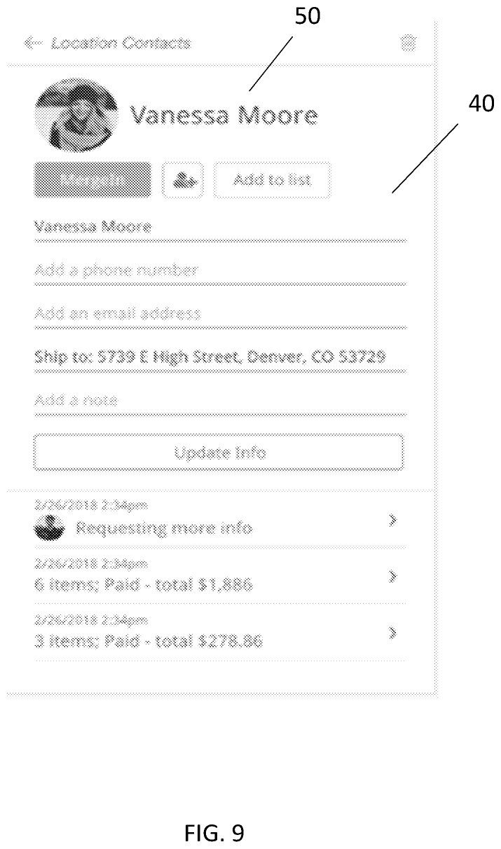

Referring again to FIG. 7, there is shown a representative video interface as viewed by a business representative 38 during a video call. As shown, a business representative 38 can be shown on the screen 40 and the consumer's real-time video can be shown in full screen view. The consumer's name 50 can also be visible, for example, on the top left navigation bar. When the consumer's name is selected, the system can direct the business representative 38 to a screen as shown in FIG. 9. As indicated at FIG. 9, a business representative 38 can view on screen 40 the caller analytics, order history, behaviors and collect the consumers mobile or email address and send a SMS or email invitation to callers to be added to the business representative's departments or personal contacts list.

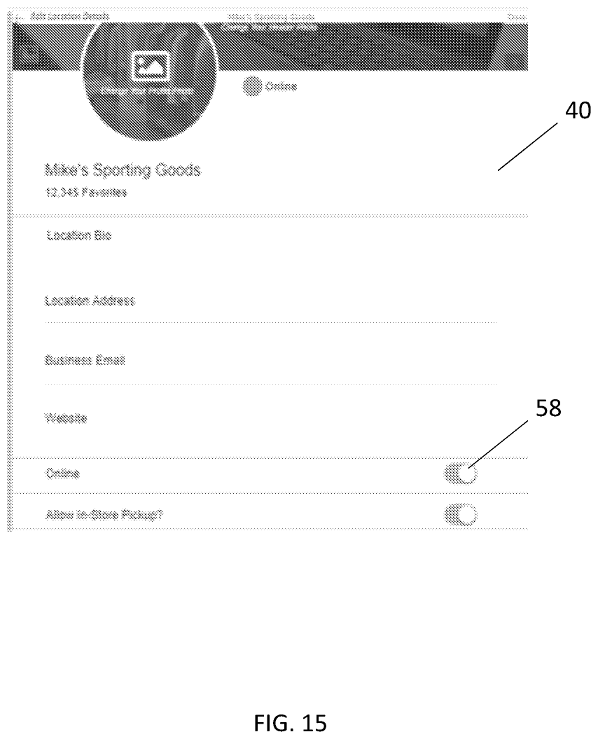

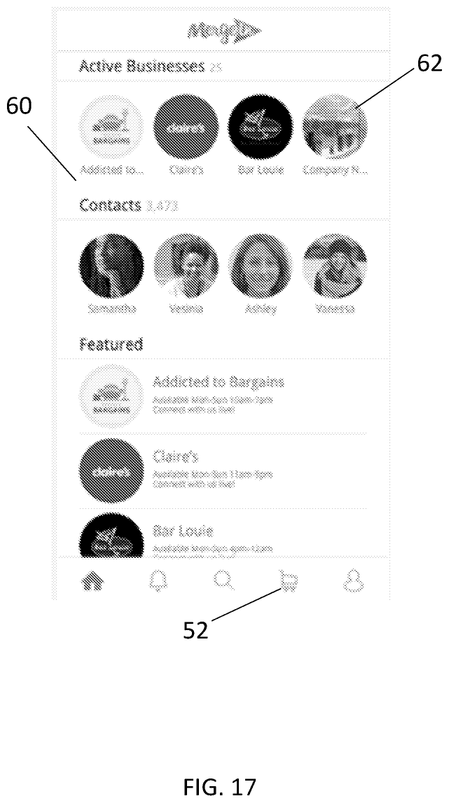

Once an invitation is accepted by a consumer the business associate(s) and the consumer can appear in each other's system contacts or a business contacts list within that business existing application, as indicated at step 114 of flow diagram 100. The consumer and business associate can then place real-time video/audio calls and send messages to each other anytime the business representatives is online as shown on FIG. 15. Also the business representative has an option to select a cart button 52 on a navigation bar (for example, as shown in the bottom navigation bar of FIGS. 7 and 17) and place items in the consumer caller's shopping cart and send the caller a bill for the items and accept payment while in the conversation. A caller, i.e., a consumer/customer, can view items in his or her cart and pay for products or services during the call, for example, in the video chat as shown in FIG. 7. The business representative can also add notes and transfer the call to anyone within his organization, as indicated at step 116 of flow diagram 100.

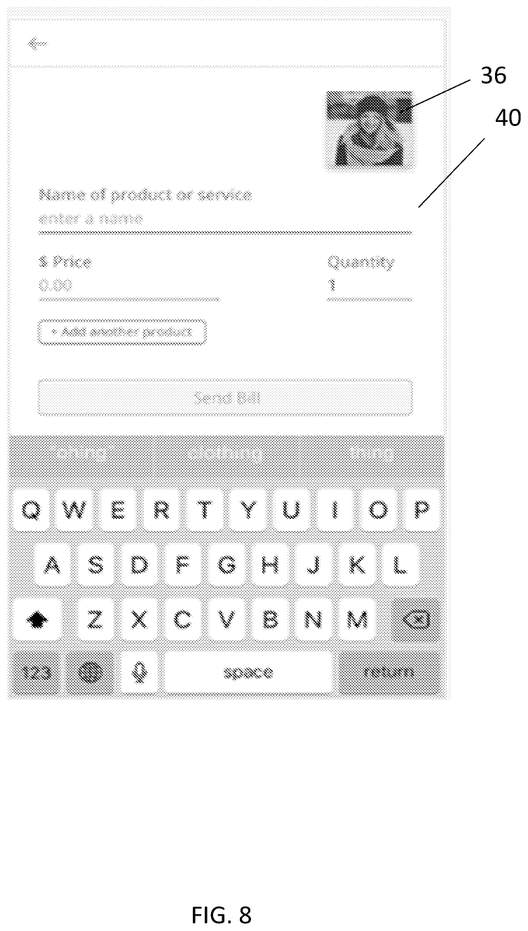

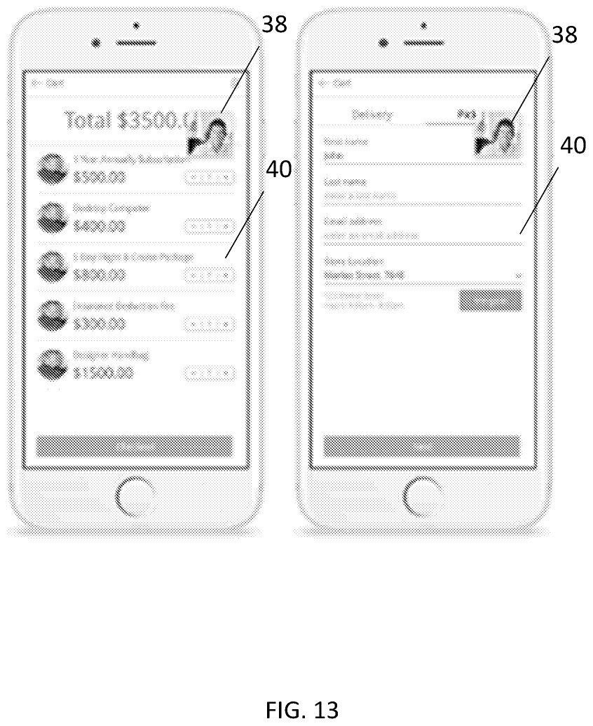

Referring now to FIG. 8, there is shown another screen shot of a business representative's in-call screen 40 interface while in a call with a consumer. The business representative can click on the cart button 52, as indicated on FIG. 7 and the screen of FIG. 8 can appear. The consumer 38 real-time video can appear on the screen 40. The business representative can then enter, such as by typing, the name of a product or scan a product with his/her camera or from a mobile device/tablet for products or services, and can enters price, availability, and/or quanitity. Once data is entered and business representative can select and send the items, which can appear in the consumer's cart as shown on the left side of FIG. 13, and as indicated at step 118 of flow diagram 100.

Referring now to FIG. 9, there is shown a profile business representative's system view. As shown, the business representative can be in a call with a consumer. A business representative can have the option to select the consumer's name 50 on a navigation bar, for example, as shown in FIG. 7. Once the button is clicked, a screen as shown in FIG. 9 can be displayed, and the consumer real-time video can overlay. The business representative can then collect information, such as the consumer's name, phone number, email address, add notes and save the customer's data. A business representative can also view the caller's, i.e., the consumer's, recent order history, view items that's in the consumer's cart and see what locations and webpages the consumer has visited.

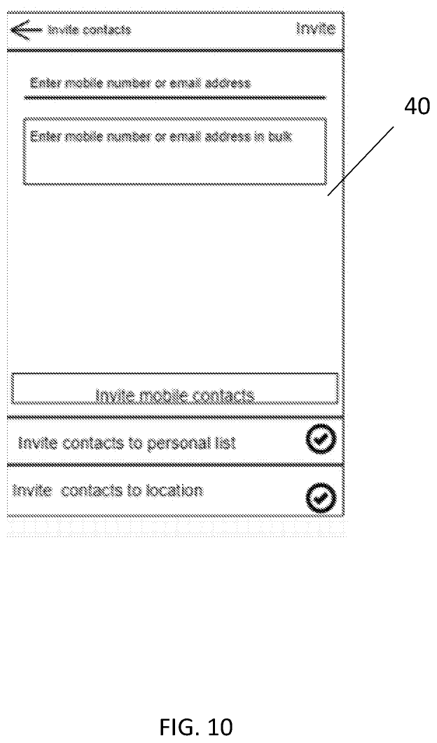

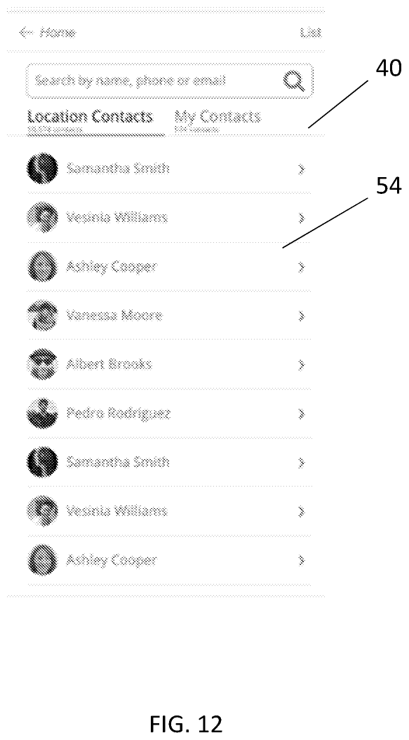

The business representative can also select the invite button as indicated in FIG. 10, and the business representative can then enter the caller's mobile or email address and send an invitation to the consumer to be added to the business representative personal or department's contacts list 54 as shown in FIG. 12. Once a caller accepts the invitation, the consumer and business associates will appear in each other's contact lists and can place real-time video/audio calls and send messages to each other anytime.

In addition, as shown in FIG. 9, the business representative can have an “Add to list” button, or the like. Once selected by the business representative, the business representative has the option to place the consumer on a specific list of customers that is labeled. The list can then be imported into multiple CRM systems (e.g., Sales Force, Hubspot, and the like).

Referring again to FIG. 10, there is shown a representative screen shot of what appears when a business representative clicks the invite button from, for example, the screen shown in FIG. 9. The business representative can enter a consumer's email address or mobile number individually or in bulk and then send invites to consumers to be added to a business location or department via MergeIn. Once the invitation is accepted by caller, any business assocates who are attached to the specific location or department the caller has been invited to can place video/audio calls and send messages to the consumer.

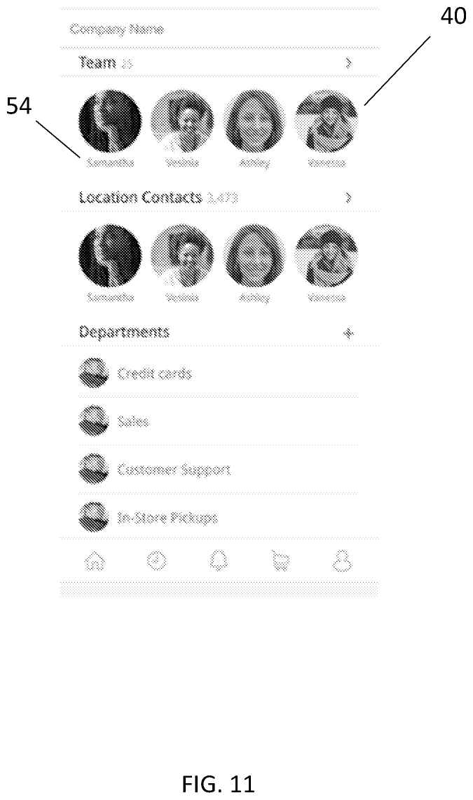

Referring to FIG. 11, there is shown a representative screen shot of a system business representative team page 54. A business representative who has been invited to a organization's system department or location by a business adnimistrator can view customer data and place realtime video/ audio calls and send messages to customers who have been invited to a business representatives location or department as show in FIG. 10. Business representatives can also search and connect live via real-time video/audio and send messages to team members within his department. Business representative can also send invites to team members in any location or department within his organization. Once invite is accepted business representative from different departments and locations buts works within the same organization can place realtime video calls and send messages to each other.

Referring to FIG. 12, there is shown a representative screen shot of a business representative's location customers/contacts page 54. A business representative who has been invited to a specific department or location can go to his location or department's contacts page and select a consumer's name, for example, as indicated in FIG. 11, and the system can then direct the business representative to a screen such as shown in FIG. 9 where business representatives can see consumer behavior, add notes and place a real-time video call to a customer.

Referring now to FIG. 13, there are shown representative system consumer's cart screens while the consumer is in a call with a business representative on the business electronic device screen 40. The business representative's 38 real-time video can appears on the screen. The consumer can pay for products or services while video chatting with a business representative. The consumer also have option to have items shipped to any address or place items on hold for in-store pickups.

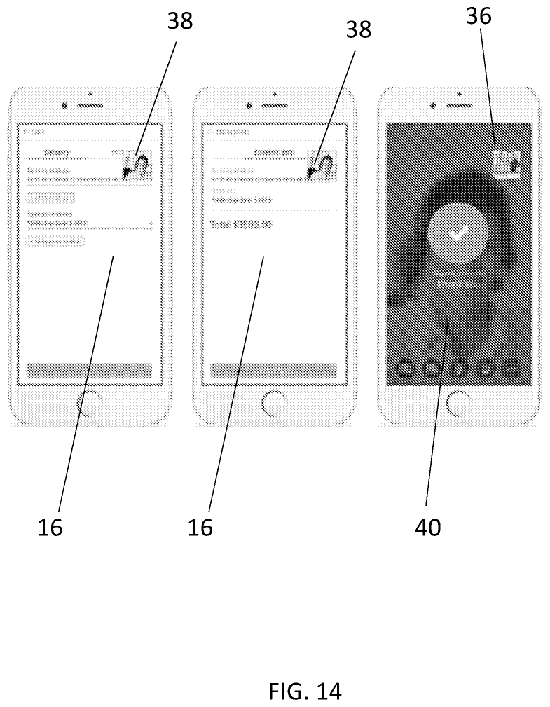

Referring now to FIG. 14, there are shown more representative system consumer's cart screens 16 while in a call with a business representative. The business representative's 38 real-time video can continue to appear in the screen. The consumer or a business admin from a different business on the system can pay for products or services while in chat with a business representative. Consumers also have the options to have items shipped to any address or place items on hold for in-store pickups. Once the customer/consumer is satisfied with either the information gained from the business representative and/or the purchase made in the online shopping cart, the call interaction can end, as indicated at step 124 of flow diagram 100.

Referring now to FIG. 15, there is shown a representative screen shot for editing a location or department of a system business page. Business administrators can select various options, including the option to toggle 56 the business location or department status on or off. If the toggle is turned on the location or department which the admin is editing will then appear online and consumers can place realtime video calls or send messages to that specific location or department.

Referring now to FIG. 16, there is shown a representative system business administrator's department or locations share page. A business representative and/or administrator can have the option to attach a code snippet to any webpage within the system website, application or anywhere online. When attached to a webpage or application page the code snippet can appears as the system icon 14, which can be, as shown, a green MergeIn button, as shown in the various FIGS., including FIG. 1, for example. System icon 13 can also be any custimized buttom and can have any image, including trademark images. When the system icon 14 is selected, a real-time video call can be placed to an attached department or location calling the queue shown in FIG. 6. FIG. 16 also shows options for business representatives to share a department with social media profiles or share the link to anyone who can access the link from a browser. Once the link is clicked the site will direct people to the specific system business location or department business profile page which the link was shared and will be directed to the business profile as shown in FIG. 2.

Referring now to FIG. 17, there is shown a representative screen shot of a system marketplace consumer view or business view 60. Consumers or business representatives can have the option to search any business on a system platform and also search for businessses and business locations and departments 62 that are active on the system. Consumers also have options to add a business to their personal contacts list, permitting consumers to place real-time video calls into a company's location or department and connect live with any available customer service representative or sales associate. Consumers also have options to send invites to private businesses on the system. Once an invite is accepted by business administrator the business, department or location and consumers can be added to each other's contacts list thus permitting business representatives in a business, department or location and consumers to participate in real-time video calls and send messages to each other.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A system for communication between business representatives and consumers, the system comprising:
a. a server comprising one or more computer-readable media maintaining instructions executable by a processor of an electronic device to perform operations comprising:
i. presenting to a consumer a digital image on a display of a consumer electronic device, the digital image comprising a system-connected business profile page comprising an item for sale and a system icon;
ii. receiving, by the consumer electronic device, a selection by the consumer of the system icon;
iii. receiving, by the consumer electronic device a selection by the consumer of a department of the system-connected business;
iv. connecting the consumer electronic device of the consumer to a business electronic device associated with the item for sale by the system-connected business selected by the consumer;
v. inviting a system-connected business representative to accept participation with the consumer;
vi. receiving, by the business electronic device, a selection by the business representative to accept participation with the consumer;
vii. initiating, by the system, a voice call between the consumer and the business representative;
viii. adding, by the business representative, the item to an online shopping cart;
ix. payment, by the consumer, for the item; and
x. ending the call.

2. The system of claim 1, wherein the item comprises one of goods and services.

3. The system of claim 1, wherein the department is selected from the group consisting of sales, customer support, in-store pickups, credit cards, store hours, and combinations thereof.

4. The system of claim 1, further comprising a system administrator and wherein the inviting step is administered by the system administrator.

5. The system of claim 1, wherein the voice call also includes video transmission.

6. The system of claim 1, further including the step of adding consumer information to a CRM system.

7. The system of claim 1, further including the step of adding consumer information to a contacts list.

8. A method for communication between business representatives and consumers, the method comprising the steps of:
a. providing a server comprising one or more computer-readable media maintaining instructions executable by a processor of an electronic device to perform operations comprising:
b. presenting on a consumer electronic device a digital image comprising a system-connected business profile page comprising one or more items for sale and a system icon;
c. receiving, by the consumer electronic device, a selection of the system icon;
d. connecting the consumer electronic device to a business electronic device associated with the system-connected business profile page;
e. inviting a system-connected business representative to accept participation with the consumer;
f. receiving, by the business electronic device, a selection to accept participation with the consumer;
g. initiating a video call between the consumer and the business representative;
h. adding at least one item of the one or more items to an online shopping cart;
i. paying for the at least one item; and
j. ending the call.

9. The method of claim 8, optionally receiving, by the consumer electronic device a selection by the consumer of a department of the system-connected business.

10. The method of claim 9, wherein the department is selected from the group consisting of sales, customer support, in-store pickups, credit cards, store hours, and combinations thereof.

11. The method of claim 8, wherein the items are selected from goods and services.

12. The method of claim 8, further providing a system administrator and wherein the inviting step is administered by the system administrator.

13. The method of claim 8, further including the step of adding consumer information to a CRM system.

14. The system of claim 1, further including the step of adding consumer information to a contacts list.

15. A system for communication between a business representative and a consumer, the system comprising a business electronic device and a consumer electronic device, and
a. a server comprising one or more computer-readable media maintaining instructions executable by a processor of an electronic device to perform operations comprising:
i. presenting to a consumer a digital image on a display of the consumer electronic device, the digital image comprising a system-connected business profile page comprising an item for sale and a system icon;
ii. receiving, by the consumer electronic device, a selection by the consumer of the system icon;
iii. connecting the consumer electronic device of the consumer to the business electronic device associated with the item for sale by the system-connected business selected by the consumer;
iv. inviting a system-connected business representative to accept participation with the consumer;
v. receiving, by the business electronic device, a selection by the business representative to accept participation with the consumer;
vi. initiating, by the system, a video call between the consumer and the business representative;
vii. adding, by the business representative, the item to an online shopping cart;
viii. payment, by the consumer, for the item; and
ix. ending the call.

16. The system of claim 15, wherein the item comprises one of goods and services.

17. The system of claim 15, wherein the department is selected from the group consisting of sales, customer support, in-store pickups, credit cards, store hours, and combinations thereof.

18. The system of claim 15, further comprising a system administrator and wherein the inviting step is administered by the system administrator.

19. The system of claim 15, further including the step of adding consumer information to a CRM system.

20. The system of claim 15, further including the step of adding consumer information to a contacts list.
